(19) United States
(12) Patent Application Publication
(10) Pub. No.: US 2021/0321723 A1
(43) Pub. Date: Oct. 21, 2021

(54) A Shoe Upper Blank and A Method for Manufacturing Thereof

(71) Applicant: Rival Shoes Design Limited, Tortola (VG)

(72) Inventors: Ricardo Da Costa Leite, Fanling (HK); Kuo Lang Pan, Tao Yan City (TW)

(21) Appl. No.: 16/496,418

(22) PCT Filed: Aug. 28, 2019
(86) PCT No.: PCT/CN2019/103002

§ 371 Date: Sep. 21, 2019

(51) Int. Cl. A43D 8/22; A43B 23/02; A43B 3/00; A43D 8/18

(52) U.S. Cl. CPC A43D 8/22; A43B 23/021; A43D 8/18; A43B 3/0078; A43B 23/0245

(57) ABSTRACT

The invention relates to a method of processing a sheet material for use in the manufacture of a product. The method comprises providing a sheet material having a first surface and a second surface; providing a two-dimensional mark on the first surface of the sheet material; arranging one or more strengthening members at one or more of the first surface and the second surface of the sheet material; imposing an indentation on said first surface of the sheet material; wherein at least part of the indentation is arranged with respect to one or more of at least part of the two-dimensional mark and at least part of the one or more strengthening members to create a three-dimensional mark on said first surface. The invention also relates to a blank for at least part of a manufactured product. The blank comprises a sheet material shaped in accordance with the at least part of a manufactured product, the sheet material comprising a two-dimensional mark on a surface of the sheet material; one or more strengthening members arranged at one or more sides of the sheeting material; wherein one or more of at least part of the two-dimensional mark and at least part of the one or more strengthening members are positioned with respect to an indentation formed in the sheet material to thereby provide a three-dimensional mark on said surface.

### FIELD OF THE INVENTION

The invention relates generally to the field of wearable product such as footwear and particularly, but not exclusively, to a shoe upper blank and a shoe upper, and a method of manufacturing thereof.

### BACKGROUND OF THE INVENTION

Various kinds of footwear such as athletic shoes in different constructions are available in the market. In general, a shoe in its typical form comprises a shoe upper which covers a foot of the wearer; and a sole or a shoe bottom which comprises the bottom portion of the shoe for supporting the foot and engaging the ground. Traditionally, blanks for shoe uppers are formed by stepwise connection of the relevant parts and components via, for example, stitching, sewing and/or binding by using adhesives and/or heat fusion techniques. In order to enhance the aesthetic appeal of the shoes as formed, decorative elements, patterns or designs are very often provided at the shoe uppers, for example, by stitching of the desired patterns and/or sewing or attaching of decorative components and/or ornaments thereon. However, all these processes are known to be time consuming as well as labor intensive, which will inevitably translate to greater costs. In addition, automation of such shoe making processes will become difficult as substantial manual operation and craftsmanship will generally still be required.

### OBJECTS OF THE INVENTION

An object of the present invention is to provide a wearable product such as a shoe and a blank for such a product, and a method of manufacturing and/or processing thereof, in which the aforesaid shortcomings are mitigated or at least to provide a useful alternative.

Another object of the invention is to mitigate or obviate to some degree one or more problems associated with known manufacturing methods of wearable products such as shoes, and/or one or more parts thereof such as shoe uppers and/or shoe upper blanks.

The above object is met by the combination of features of the main claims; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a method of processing a sheet material for use in the manufacture of a products. The method comprises providing a sheet material having a first surface and a second surface; providing a two-dimensional mark on the first surface of the sheet material; arranging one or more strengthening members at one or more of the first surface and the second surface of the sheet material; imposing an indentation on said first surface of the sheet material; wherein at least part of the indentation is arranged with respect to one or more of at least part of the two-dimensional mark and at least part of the one or more strengthening members to create a three-dimensional mark on said first surface.

In a second main aspect, the invention provides a method of manufacturing a product comprising the step of forming a blank from a sheet material processed according to the method of the first main aspect to form a shoe upper.

In a third main aspect, the invention provides a blank for at least part of a manufactured product. The blank comprises a sheet material shaped in accordance with the at least part of a manufactured product, the sheet material comprising a two-dimensional mark on a surface of the sheet material; one or more strengthening members arranged on one or more sides of the sheeting material; wherein one or more of at least part of the two-dimensional mark and at least part of the one or more strengthening members are positioned with respect to an indentation formed in the sheet material to thereby provide a three-dimensional mark on said surface.

In a fourth main aspect, the invention provides a shoe upper. The shoe upper comprises the blank according to the third main aspect.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is a top view of the formed shoe upper blank in accordance with an embodiment of the present invention;

FIG. 2 is a top view showing a sheet material for preparing a shoe upper blank in accordance with an embodiment of the present invention showing the outlines of a shoe part;

FIG. 3 is a top view showing the sheet material of FIG. 2 showing an embodied two-dimensional pattern in accordance with the present invention;

FIG. 4 is a top view showing the sheet material of FIG. 3 having the two-dimensional patterns with colors;

FIG. 5 is a top view showing the strengthening materials in accordance with an embodiment of the present invention;

FIG. 6 is top view showing a mold applicable in preparing the shoe blank of FIG. 1;

FIG. 7 shows the strengthening members of FIG. 5 being placed on the mold of FIG. 6;

FIG. 8 shows the sheet material of FIG. 4 being placed on top of the strengthening members and the mold of FIG. 7;

FIG. 9 shows the placing of further strengthening members on the back side of sheet material; and

FIG. 10 shows the shoe upper blank after the pressing step and prior to cutting of the sheet material in accordance with the outlines of the shoe part.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In the claims hereof, any element expressed as a means for performing a specified function is intended to encompass any way of performing that function. It is thus regarded that any means that can provide those functionalities are equivalent to those shown herein.

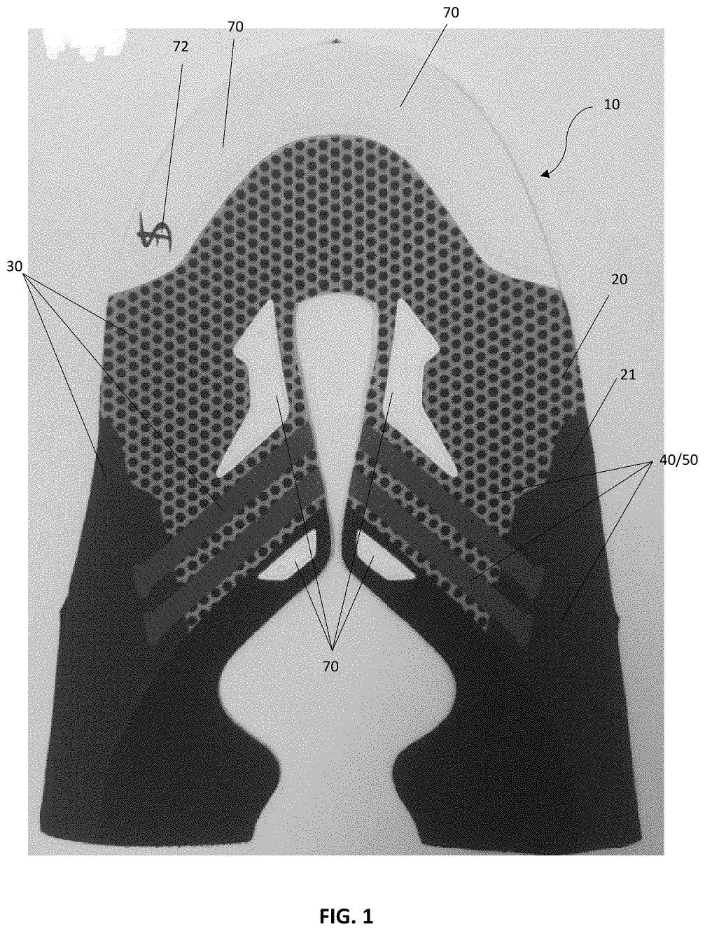

The present invention relates to a blank for a wearable product or a part of a wearable product such as a shoe upper and a method of manufacturing thereof. Referring to FIG. 1, shown is a shoe upper blank 10 according to an embodiment of the present invention. The blank 10 may comprise a sheet material 20 having a first, upper surface 21 and a second, lower surface 22. The sheet material 20 is preferably shaped in accordance with the shoe upper to be formed, with the sheet material 20 being provided with one or more two-dimensional marks 30 on one of the surfaces, such as the upper surface 21, of the sheet material 20.

In one embodiment, the shoe upper blank 10 preferably comprises one or more strengthening members 70 arranged at the sheet material 20, and more particularly, at one or more of the upper surface 21 and the lower surface 22 of the sheet material 20. The one or more strengthening members 70 are provided with an aim to enhance or to reinforce mechanical properties such as strength, resilience and/or wear resistance of the formed shoe upper blank.

Preferably, at least part of the two-dimensional marks 30 on the sheet material 20 and/or the strengthening members 70 are arranged to position with respect to one or more respective indentations 40 formed in the sheet material 20 to thereby provide one or more three-dimensional marks 50 on the surface, as shown in FIG. 1. More preferably, each indentation 40 is arranged with respect to and/or to coincide with the at least part of the respective two-dimensional mark 30 of the sheet material 20 and/or the strengthening members 70 thereby creating the corresponding three-dimensional 50 mark to mimic a textural effect in the material of the blank 10. The textural effect may comprise, but is not limited to, one or more of a knitted, stitched, sewed fabric pattern and/or any other known patterns of fabrics, as shown in FIG. 1.

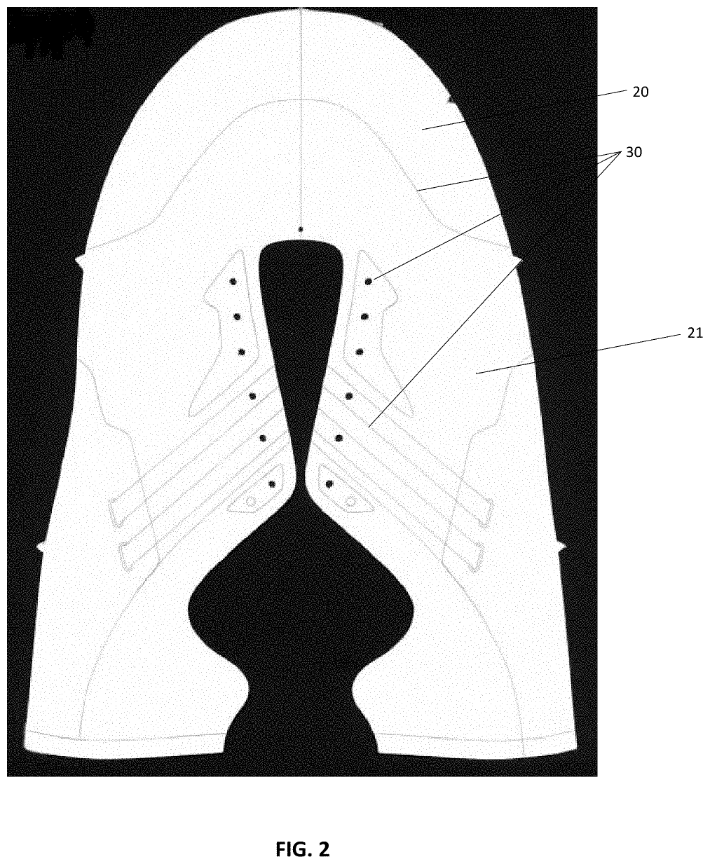

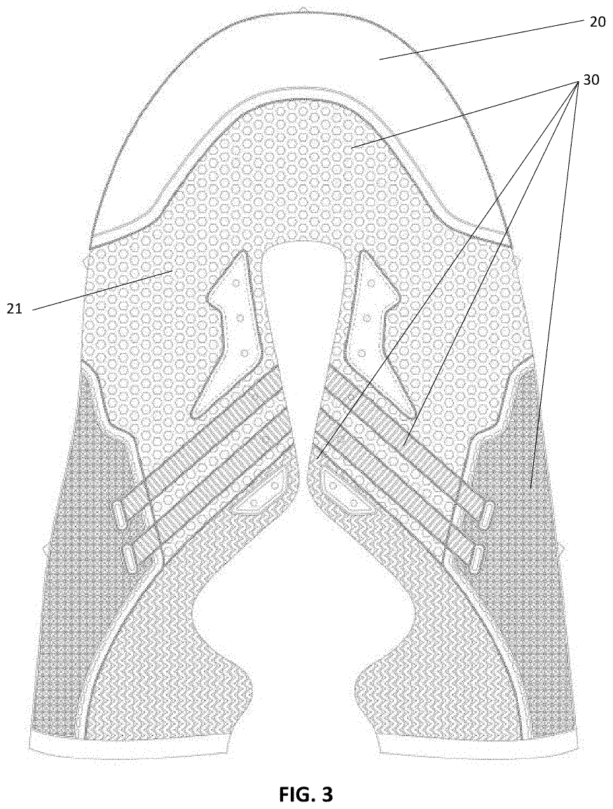

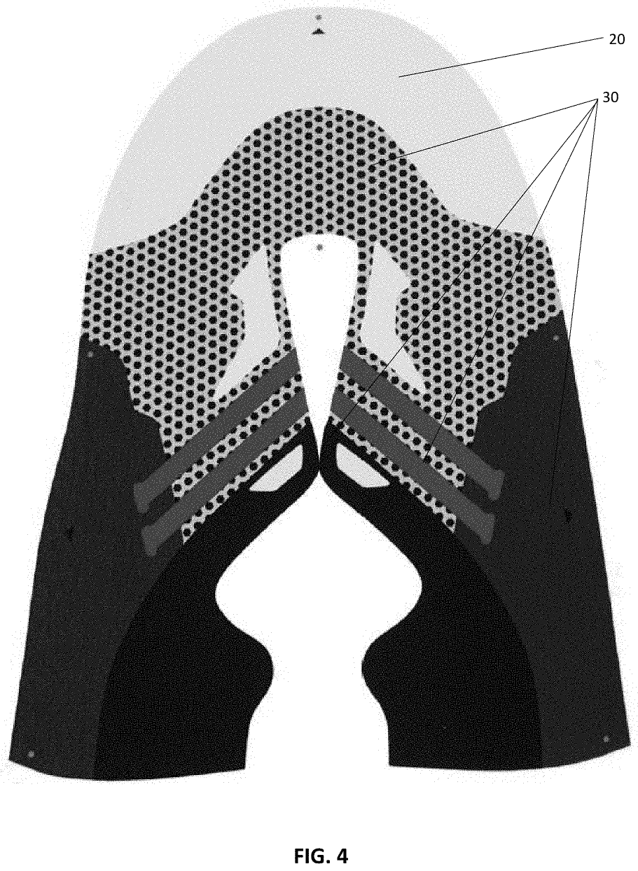

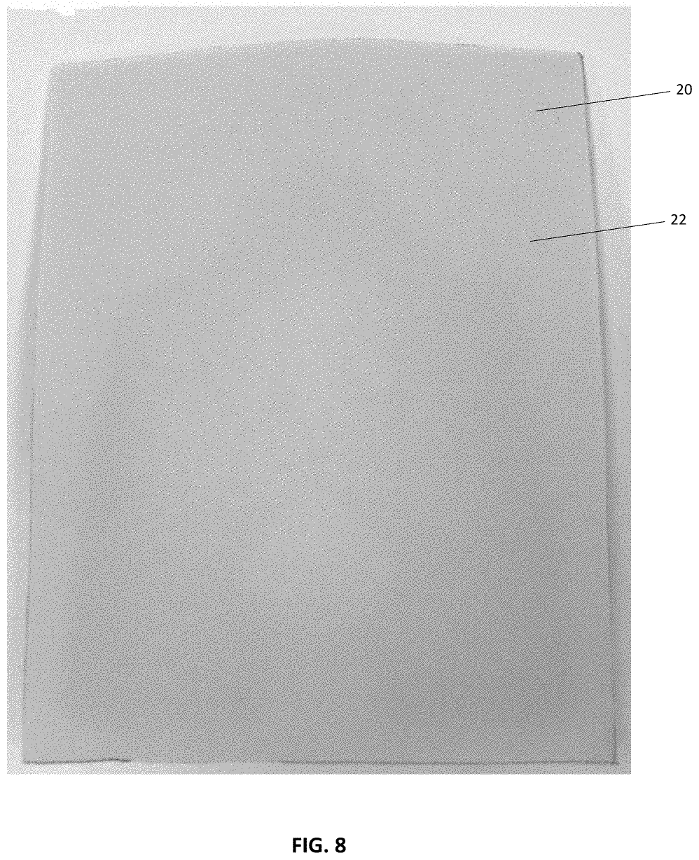

FIGS. 2-10 further illustrate the steps of manufacturing the shoe upper blank 10. First, a sheet material 20, which can be formed of any known fabric or a composition of laminated fabric materials suitable for preparing a shoe upper blank, is provided. A two-dimensional mark 30 or a plurality of such marks 30 may then be provided on a surface, preferably the upper surface 21, of the sheet material 20 by, for example, writing, drawing, painting, staining, printing and/or stamping on said surface. The two-dimensional mark 30 may comprise, for example, an outline of a part or all of the shoe upper, as shown in FIG. 2. The two-dimensional mark 30 may also comprise one or more of a line, a pattern, a color, an icon, a picture, a shape, a word, a symbol and/or a decorative element, such as the two-dimensional pattern as shown in FIGS. 3 and 4. Preferably, the two-dimensional pattern 30 is arranged to fill at least partially the outline of the part or all of the shoe upper, as shown in FIGS. 3 and 4. In one embodiment, the two-dimensional marks or patterns 30 can be provided by any known printing techniques, such as but not limited to, sublimation printing, silk screen printing and/or digital printing. In one further embodiment, the two-dimensional patterns 30 can be formed by scanning the appearance of a fabric material having the desired texture and/or arrangement, for example, a fabric with decorative stitched patterns by a suitable scanner; optionally editing the scanned images by a computer software; and subsequently, printing of such images onto the sheet material 20 via, for example, a computer controlled printer, etc.

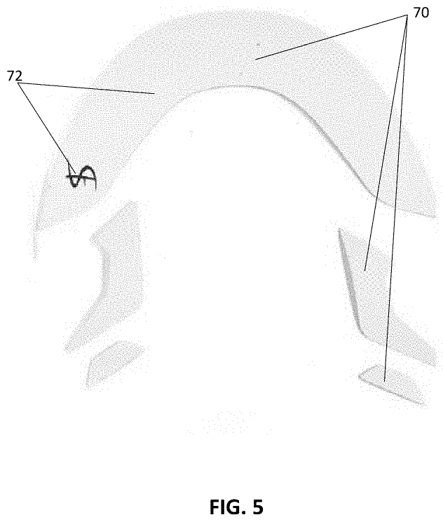

FIG. 5 shows a plurality of strengthening members 70 which have been prepared in various shapes and sizes in accordance with the corresponding parts of the shoe product. Particularly, the strengthening members 70 are preferably arranged at locations of the shoe parts at which an enhanced mechanical characteristic is desired or required. For example, the strengthening members 70 can be shaped to conform with configurations of, for example, the toe cap and/or the eyestay regions of the shoe blank 10, as shown in the figures, although it will be appreciated by a person skilled in the art that the strengthening members may well be applicable to any other shoe parts of the blank such as, the eyelet region, the quarter panel, the heel counter and/or any other parts and regions of the shoe blank of which an enhanced mechanical strength and/or durability is desired or required.

In one embodiment, the strengthening members 70 are preferably formed of materials such as polymeric materials and/or leather materials. More preferably, the polymeric materials may comprise polyurethane (PU) materials, such as thermoplastic urethane (TPU) sheet materials. The leather materials may comprise genuine leather (such as, but are not limited to, napa leather and nubuck leather, etc.) and synthetic leather (such as, but are not limited to, PU microfiber leather and microfiber suede leather, etc.). The strengthening members 70 are preferably to be of a thickness of about 0.1 mm to about 5 mm, and more preferably, about 0.15 mm to about 3.5 mm. In one preferred embodiment, the strengthening members 70 may exhibit a tensile strength of about 10 MPa to about 100 MPa; a hardness (Shore A) of about 50 to about 100; and a density of about 1 g/cm³ to about 5 g/cm³, and more preferably, about 1 g/cm³ to about 2 g/cm³. In one specific embodiment, the strengthening members 70 formed of thermoplastic urethane (TPU) sheet materials having a thickness of about 0.5 mm to about 0.6 mm are found to demonstrate physical properties as shown in Table 1 below:

TABLE 1
Physical properties of a typical strengthening member.

| Physical Properties | | | Test Procedure |
|---|---|---|---|
| Hardness | 80 (Shore A) | | DIN ISO 7619-1 |
| Density | 1.18 | g/cm3 | DIN EN ISO 1183-1-A |
| Tensile strength | 50 | MPa | DIN 53504-S2 |
| Elongation break | 650% | | DIN 53504-S2 |
| Stress at 300% elongation | 8 | MPa | DIN 53504-S2 |
| Tear strength | 60 | KN/m | DIN ISO 034-1B |
| Abrasion | 30 | mm3 | DIN ISO 4649-A |

| | | |
|---|---|---|
| Compression set at 23 | 25% | DIN ISO 815 |
| degree C./72 hrs | | |

In one further embodiment, the strengthening members 70 may optionally comprise or be provided with one or more marks 72 such as one or more two-dimension marks 72 on its surfaces such as the upper surface. The marks 72 can be formed by any known marking means, such as those as applicable to the marking of the two-dimensional marks 30 of the sheet material 20 as described above. For example, the mark 72 can be provided by writing, drawing, painting, staining, printing and/or stamping on at least part of the surface of the strengthening member 70. The marks 72 may further comprise one or more of a line, a pattern, a color, an icon, a picture, a shape, a word, a symbol and/or a decorative element. For example, at least part of the surface of the strengthening members 70 can be filled with one or more colors and/or patterns. The marks 72 may also be provided by any known printing techniques, such as but not limited to, sublimation printing, silk screen printing and/or digital printing, etc. In one further embodiment, marks 72 can be formed by scanning the appearance of a fabric material having the desired texture and/or arrangement, for example, a fabric with decorative stitched patterns by a suitable scanner; optionally editing the scanned images by a computer software; and subsequently, printing of such images onto the surface of the strengthening members 70 via, for example, a computer controlled printer, etc.

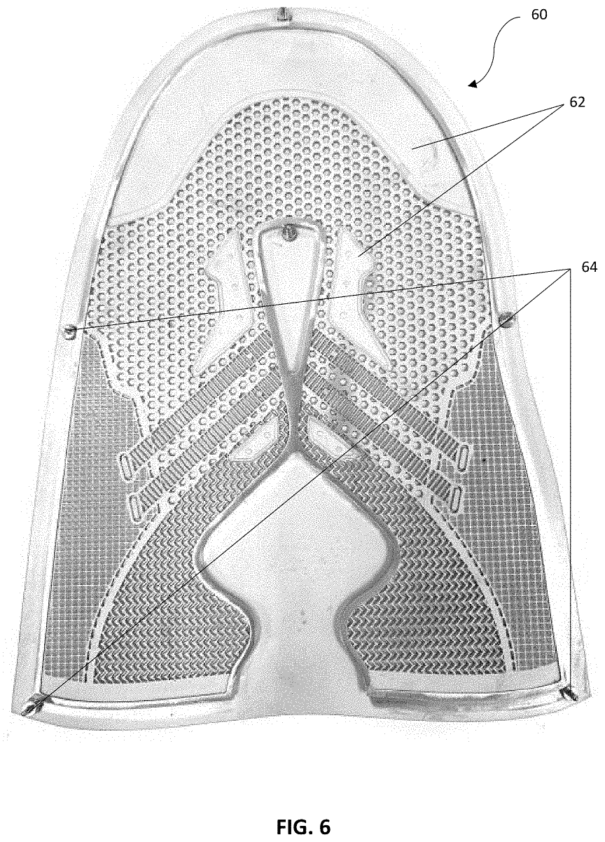

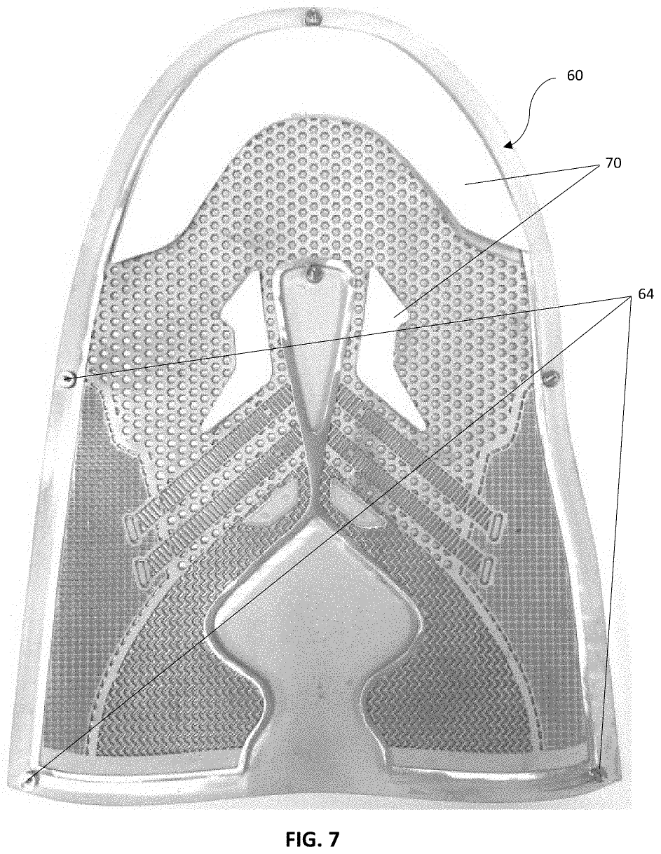

The printed surfaces of the sheet material 20 along with the strengthening members 70 will then be pressed in a mold to thereby impose one or more indentations 40 on the blank material. Particularly, at least part of each indentation 40 is arranged with respect to at least part of a respective two-dimensional pattern 30 and/or at least part of the strengthening member 70 to create a three-dimensional mark 50 on the printed surface. In one embodiment, at least part of the indentation 40 is preferred to be arranged with respect to, and to coincide with at least part of the two-dimensional pattern 30 and/or the strengthening member 70 to create the three-dimensional mark 50 to thereby mimic a desired textural effect such as a knitted, stitched, sewed fabric pattern and/or any design of decorative textures on the blank material. As shown in FIGS. 6-10, for example, the indentations 40 can be provided by using the mold 60 as shown in FIG. 6, which is configured with respect to the corresponding two-dimensional patterns 30 of the sheet material 20 and locations of the strengthening members 70 at the shoe upper blank 10. In one embodiment, the mold 60 may comprise a molding surface carrying the mold pattern which includes, for example, a plurality of protrusions and/or recesses, with the molding surface being arranged to support, engage and/or to face the printed surface of the sheet material 20 and/or the strengthening members 70. The molding surface may further be configured to comprise one or more depressed, receiving portions 62 for receiving, accommodating and positioning one or more strengthening members 70 at the mold 60, as shown in FIGS. 6 and 7, which illustrate the mold 60 before and after placing of the strengthening members 70 at the respective receiving portions 62 at the mold surface. The receiving portions 62 serve an important function in positioning the strengthening members 70 at the mold surface and thus, displacement of the strengthening members 70 relative to the sheet material 20 during pressing can be avoided or minimized. It should be understood that, if the strengthening members 70 have priorly been marked or printed with one or more marks 72, the surface of the strengthening member 70 carrying such marks should be arranged to face towards the molding surface when it is placed at the corresponding receiving portion 62.

After arranging the strengthening members 70 at the mold surface, the sheet material 20 is then placed onto the mold 60, with the upper surface 21 carrying the two-dimensional marks 30 being arranged to face and to overlay at least partially the strengthening members 70. Preferably, the sheet material 20 is positioned relative to the mold 60 by aligning the two-dimensional pattern 30 with the mold pattern of the mold 60 to thereby increase precision of the next pressing step, with the alignment being preferably assisted by using a positioning means such as one or more pins 64 arranged at the mold 60 adapted to engage one or more corresponding through holes at the sheet materials for positioning.

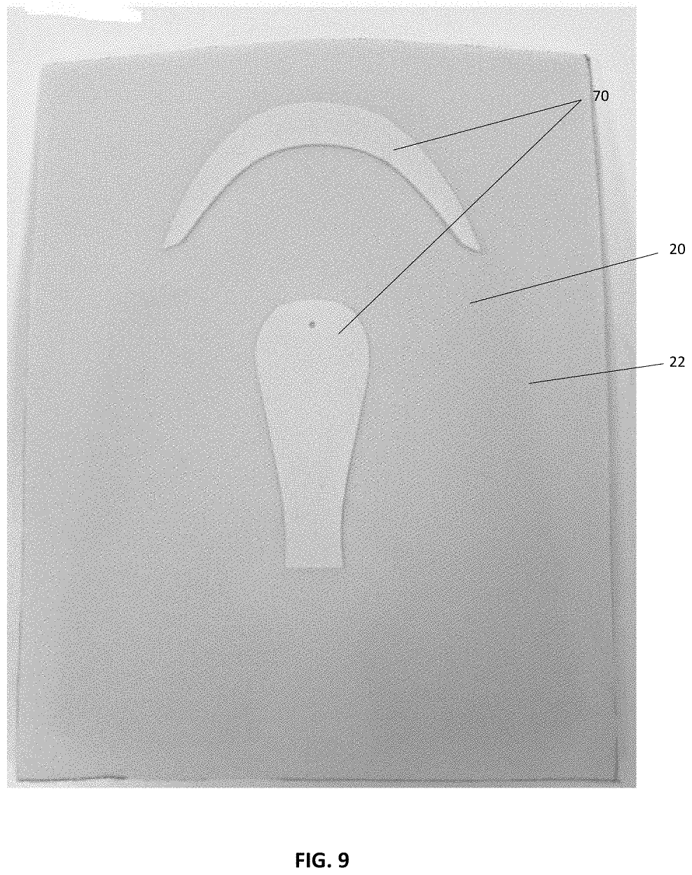

In another embodiment, additional strengthening members 70B may further be arranged at the lower surface 22 of the sheet material 20 after the sheet material 20 is placed on top of the strengthening members 70 and the mold 60, as shown in FIG. 9. The strengthening members 70B provide additional mechanical support to the rear side of the blank 10 and again, at locations at which additional strength, thickness and/or wear assistance of the shoe parts are required.

The next step is to apply pressure onto the sheet material 20 along with the strengthening members 70, 70B via the mold 60 to thereby impose the indentations 40 onto the printed surface. This pressing step may further be assisted by or be conducted under heat treatment and/or vacuum suction, such as by heating the sheet material 20 and/or the mold 60, and/or by applying vacuum to the process with an aim to enhance efficacy of the pressing step. After the pressing step which may optionally be conducted under heat and/or vacuum, a cooling step may also be provided to the molding process. The cooling step is found to be advantageous to the formation of the indentations 40 and particularly, in forming more distinct three-dimensional patterns 50 based on the indentations 40. In one specific embodiment, the pressing step can be conducted under pressure at about 25 kg/cm to about 80 kg/cm, heat treatment at about 80 deg C. to about 200 deg C. for about 30 seconds to about 90 seconds, and subsequently, cooling at about 0 deg C. to about 20 deg C. under the pressure of about 25 kg/cm to about 80 kg/cm for about 10 seconds to about 60 seconds.

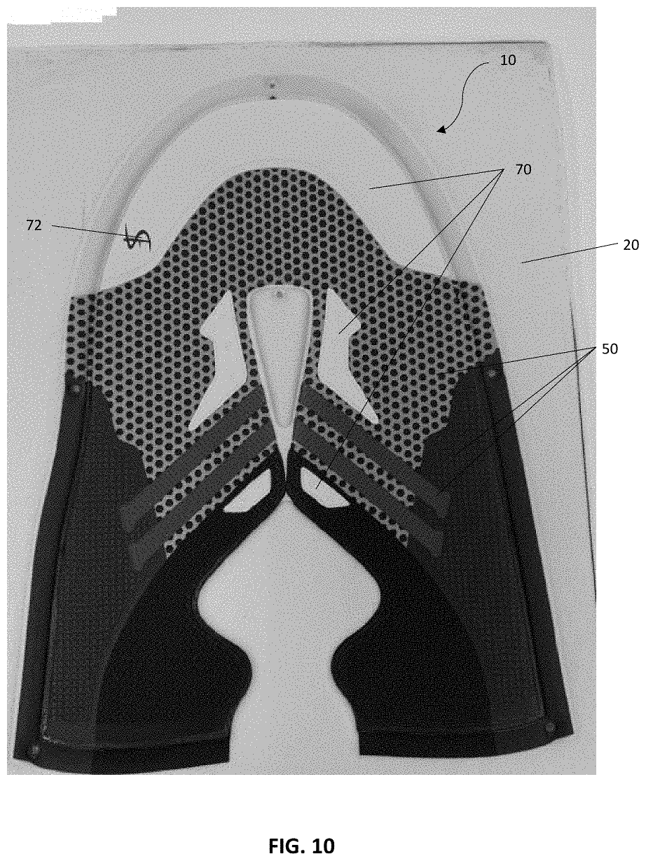

FIG. 10 shows the front side of the sheet material 20 after the pressing step, with the imposed indentations 40 creating a three-dimensional texture 50 which mimics the effect of a stitched and/or sewed fabric pattern, for example. The indentations 40 may comprise a plurality of indentations 40 which can be of identical depth or different depths to thereby create one or more different 3-D textural effects. To allow formation of the indentations 40, the sheet material 20 is preferably compressible at least along a direction transverse to the printed surface. More preferably, the sheet material may be compressible by about 5% to about 30% in respect of its total thickness. In one embodiment, the sheet material 20 may be formed of one or more of materials selected from a group consisting of polyester based materials, spandex, neoprene, nylon, polyurethane based materials, synthetic leather, genuine leather, animal skins, denim, canvas, suede or suede effect materials, polyvinyl chloride, acrylic materials, recycled materials, degradable materials and/or any fabric sheet materials which demonstrate the required compressibility such as sponge or foam sheet materials such as any one or more of ethyl vinyl acetate (EVA), polyethylene (PE), styrene butadiene rubber (SBR), polyurethane (PU), latex, or neoprene, and can be of a thickness ranged from about 0.2 mm to about 30 mm. In one further embodiment, the sheet material 20 can be a laminated sheet material having a plurality of layers of materials, with the first upper layer comprising, for example, polyester based materials, spandex, neoprene, nylon, polyurethane based materials, synthetic leather, genuine leather, animal skins, denim, canvas, suede or suede effect materials, polyvinyl chloride and/or acrylic materials. or the like, and/or preferably, with a thickness of about 0.2 mm to about 3.0 mm. The laminated sheet may further comprise a second layer of material comprising a foam material or foam-like material, with the foam material or foam-like material preferably having a thickness of about 0.2 mm to about 30 mm and/or a density of about 10 g/cm³ to about 60 g/cm³. In general, the first upper layer comprises a material which is selected to have a stiffness which retains a deformation when said material is subjected to an indentation process, while the second lower layer comprises a material with a greater degree of compressibility than the material of the first upper layer to thereby accommodate a deformation in the first upper layer. In the context of the present invention, the term “material” or “sheet material” shall not be limited to any specific material and/or fabric, or any type of materials and/or fabrics, but may comprise any suitable and/or applicable materials for wearable products and/or accessories in general.

After the provision of the 3-D marks 40 or patterns 50 on the blank material, the sheet blank material may then be cut in accordance with the outline of the part or all of the shoe upper or the printed area of the part or all of the shoe upper to form the blank 10. In one embodiment, the blank 10 is preferred to be formed in one single piece and be configured in a substantially U or V-shape having a closed end at one longitudinal end and an open end at the opposite longitudinal end of the blank 10. The blank 10 is also preferred to be symmetric in shape along a central longitudinal axis, such that a shoe upper with symmetric left and right sides can be formed by for example, shaping and/or folding of the blank 10 about its central longitudinal axis.

As described earlier, the provision of the strengthening members 70 at the blank material is beneficial in enhancing mechanical properties at selected regions or locations of the shoe blank 10, at which enhanced or reinforced mechanical properties such as mechanical strength, wear resistance and/or material resilience, etc. are desired or required. The strengthening members 70 can be arranged at one side or both sides of the sheet material 20, and that for the strengthening members 70 which are arranged on the upper side or surface 21 of the sheet material 20, they may further serve to decorate the shoe blank 10, especially when they are priorly printed with various colors and/or patterns 72.

The improved mechanical properties are found to include, but are not limited to, tensile strength, percentage elongation, tear strength, burst strength and/or abrasion, etc. and that comparison of these parameters of a shoe blank prepared with and without the strengthening members 70 are shown in Table 2 below. Specifically, the mechanical tests were conducted by using the prepared shoe blank sample as shown in FIG. 10 (i.e. the sample “with strengthening members”), and that the strengthening members 70 are omitted from the same shoe blank sample in forming the control experiment (i.e. the sample “without strengthening members”). The results demonstrate a significant increase in every of the parameters being tested, which showed that the improved and enhanced mechanical properties are attributed to the inclusion of the strengthening members 70 to the blank material.

TABLE 2
Comparison of mechanical properties of the blank with and without
the strengthening members. The strengthening members are formed
of TPU with physical properties shown in Table 1.

| | Without | With |
|---|---|---|
| | Strengthening | Strengthening |
| Mechanical Properties | Members | Members |
| Tensile Strength (MPa) | 25.2(L), 23.6(W) | 55.6(L), 39.6(W) |
| Elongation (%) | 27.4(L), 26.4(W) | 245(L), 86(W) |
| Tear Strength (KN/m) | 51.4(L), 55.0(W) | 95.3(L), 88.8(W) |
| Burst Strength (Kgf/cm²) | 13.5 | 17.7 |
| Abrasion (Cycles) | 3200 | 6400 |

The shoe blank 10 may further comprise one or more shoe parts and/or accessories connected to the sheet material 20, for example, the shoelace rings and/or a shoe tongue (not shown). In one further embodiment, the sheet material 20 may be punched or pierced to provide one or more through holes which can be used as a passageway for a shoelace, and/or for the fitting of one or more eyelets, loops and/or hooks for tying a shoelace. Alternatively, the through holes may serve a decorative purpose, for example, to allow a bottom layer material attached underneath the sheet material 20, preferably having a different color to the printed surface, to be visible via the through holes, etc.

The present invention further relates to a shoe upper and a method of manufacturing thereof. Particularly, the shoe upper blank 10 as described above can be processed to form a shaped shoe upper. For example, the shoe upper can be formed by one or more of connecting, shaping, sewing, stitching, adhering and/or heat fusing steps of at least part of the blank 10. In one embodiment, the blank 10 may be connected via one or more connecting means, for example, via hot melt film pressing stitching or the like. Preferably, the shoe upper can be formed by shaping and connecting only one single blank. The present invention is therefore advantageous in providing a one-step manufacturing method, which significantly simplifies the manufacturing process for a shoe upper compared to the conventional, multi-step manufacturing process for a shoe upper. The one-step process reduces, minimises or negates the part-by-part sewing, stitching and/or in general, connecting operation in putting the various components of a conventional shoe upper blank together.

Although a footwear or a shoe in the form of a sport shoe is illustrated in the drawings, a person skilled in the relevant art would appreciate that the present invention is limited to any specific shoe types as described or illustrated. Instead, the present invention can be used to form various kinds wearable products such as, but are not limited to, footwear or shoes including boots, sandals, thongs, slippers and footwear with or without heels, and/or any wearable products or accessories of apparel such as bags, handbags, belts head or wrist bands or the like.

In general, the present invention provides a blank for a wearable product or a part of a wearable product such as a shoe upper, and a method of manufacturing thereof. The blank, preferably in a one-piece configuration, comprises a sheet material shaped in accordance with a shoe upper, and one or more strengthening members for providing the blank with an enhanced mechanical support. The present invention is advantageous in providing a simple, fast and versatile method in preparing a shoe upper blank with a texture of, for example, a knitted, stitched and/or sewed effect, without the need of an actual knitting, stitching and/or sewing step at the blank or the shoe upper. The two-dimensional mark and thus the resulting three-dimensional pattern can be any computer generated or processed graphics, photos and/or images, which can be readily produced and printable onto the sheet material by known printing methods. The processing steps are relatively simple, fast and non-expensive, which allows the three-dimensional, textural patterns be generated and reproduced at high efficiency and consistency. Furthermore, the provision of the strengthening members to the blank material is beneficial in enhancing or reinforcing mechanical properties at selected regions of the shoe blank, of which an improved mechanical strength, resilience and/or durability are achievable. The strengthening members may priorly be printed with decorative colors and/or patterns such that, when being provided at the upper side of the shoe blank, provides further decorative effects to the overall shoe blank design.

The present invention is beneficial in allowing a semi- or fully automated process in the making of shoe, which significantly simplifies the conventional, multi-steps manufacturing process, as well as enhances quality and reproducibility of the resulting shoes. The present invention also assists in reducing, minimising or negating some or most of the traditional manual operations generally required in a shoe making process, which are known to be cost and labour demanding.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. A method of processing a sheet material for use in the manufacture of a product, comprising:
providing a sheet material having a first surface and a second surface;
providing a two-dimensional mark on the first surface of the sheet material;
arranging one or more strengthening members at one or more of the first surface and the second surface of the sheet material;
imposing an indentation on said first surface of the sheet material;
wherein at least part of the indentation is arranged with respect to one or more of at least part of the two-dimensional mark and at least part of the one or more strengthening members to create a three-dimensional mark on said first surface.

2. The method according to claim 1, wherein said one or more strengthening members are formed of materials selected from a group consisting of polymeric materials and leather materials.

3. (canceled)

4. (canceled)

5. The method according to claim 1, wherein said one or more strengthening members are of one or more of a tensile strength of about 10 MPa to about 100 MPa; a hardness of about 50 Shore A to about 100 Shore A; and a density of about 1 g/cm³ to about 5 g/cm³.

6. (canceled)

7. (canceled)

8. The method according to claim 1, wherein said one or more strengthening members are arranged at one or more locations on one or more of the first surface and the second surface of the sheet material at which enhanced mechanical characteristics of the manufactured product at said locations are required.

9. The method according to claim 8, wherein said one or more locations comprise one or more representing locations of a toe cap, an eyestay, an eyelet, a quarter panel and a heel counter on the sheet material for the manufacturing of a shoe product.

10. The method according to claim 1, further comprising a step of providing a mark at the strengthening members prior to the step of arranging the strengthening members at one or more of the first surface and the second surface of the sheet material; wherein the mark comprises a two-dimensional mark having one or more of a line, a pattern, a color, an icon, a picture, a shape, a word and/or a symbol and a decorative element.

11. (canceled)

12. The method according to claim 1, wherein said at least part of the indentation is arranged to coincide with one or more of said at least part of the two-dimensional mark of the sheet material and said at least part of the strengthening members; said at least part of the indentation is arranged with respect to one or more of said at least part of the two-dimensional mark of the sheet material and said at least part of the strengthening members to create one or more three-dimensional marks on said sheet material carrying the strengthening members and/or the strengthening members to thereby mimic a three-dimensional textural effect of a material of a blank for at least part of a manufactured product formed from said processed sheet material.

13. (canceled)

14. The method according to claim 13, wherein the three-dimensional mark mimics a three-dimensional textural effect of the material of the blank for the at least part of the manufactured product of one or more of a knitted, stitched and/or sewed fabric pattern.

15. The method according to claim 1, wherein the step of providing the two-dimensional mark is conducted by one or more of writing, drawing, painting, staining, printing and/or stamping on said first surface of the sheet material.

16. (canceled)

17. (canceled)

18. (canceled)

19. (canceled)

20. The method according to claim 10, wherein the step of providing the mark at the strengthening members is conducted by one or more of writing, drawing, painting, staining, printing and/or stamping on at least a surface of the strengthening members.

21. (canceled)

22. (canceled)

23. (canceled)

24. The method according to claim 1, wherein the step of imposing an indentation comprises one or more of the steps of: applying pressure by using a mold, applying heating on the sheet material, and applying vacuum on the sheet material to form one or more indentations.

25. The method according to claim 24, wherein the step of imposing an indentation further comprises a cooling step after the one or more steps of the pressure-applying step, the heat-applying step and the vacuum-applying step.

26. The method according to claim 1, wherein the step of imposing comprises:
placing one or more first strengthening members of the one or more strengthening member onto a molding side of a mold;
placing said first surface of the sheet material carrying the two-dimensional mark onto the mold side the mold at which the one or more first strengthening members are placed; and
applying pressure to the mold carrying the sheet material and the one or more first strengthening members.

27. The method according to claim 26, wherein the imposing step further comprises the step of placing one or more second strengthening members of the one or more strengthening members onto the second surface of the sheet material after the step of placing said first surface of the sheet material onto the mold and prior to the pressure applying step.

28. The method according to claim 26, further comprising one or more of the following steps during or after the pressure-applying step: applying heating and applying vacuum to the sheet material and the one or more strengthening members; and a cooling step.

29. (canceled)

30. The method according to claim 26, wherein the imposing step further comprises positioning the sheet material relative to the mold by aligning the two-dimensional mark and the one or more strengthening members with a mold pattern at the molding side of the mold by using one or more positioning means arranged at the mold.

31. (canceled)

32. (canceled)

33. The method according to claim 1, wherein the processed sheet material is processed to form a shoe upper blank and the method further comprises a step of connecting one or more shoe parts to the processed sheet material comprising the shoe upper blank after the imposing step.

34. A method of manufacturing a product, comprising:
forming a blank from a sheet material processed according to the method of claim 1; wherein the blank comprises a shoe upper blank and the shoe upper is formed by processing only a single blank.

35. (canceled)

36. (canceled)

37. (canceled)

38. A blank for at least part of a manufactured product, the blank being formed from the method of claim 1, comprising:
a sheet material shaped in accordance with the at least part of a manufactured product, the sheet material comprising a two-dimensional mark on a surface of the sheet material;
one or more strengthening members arranged at one or more sides of the sheeting material;
wherein one or more of at least part of the two-dimensional mark and at least part of the one or more strengthening members are positioned with respect to an indentation formed in the sheet material to thereby provide a three-dimensional mark on said surface.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. The blank according to claim 38, wherein said one or more strengthening members are formed of materials selected from a group consisting of polymeric materials comprising polyurethane materials, and leather materials comprising synthetic leather materials.

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)
